(19) United States
(12) Patent Application Publication
(10) Pub. No.: US 2011/0099107 A1
(43) Pub. Date: Apr. 28, 2011

(54) METHOD FOR MONEY TRANSFER USING A MOBILE DEVICE

(75) Inventors: Ashutosh Saxena, Ahmedabad (IN); Meena Dilip Singh, Bangalore (IN)

(73) Assignee: INFOSYS TECHNOLOGIES LIMITED, Bangalore (IN)

(21) Appl. No.: 12/814,568

(22) Filed: Jun. 14, 2010

(30) Foreign Application Priority Data
Oct. 23, 2009 (IN) 2560/CHE/2009

(51) Int. Cl. G06Q 40/00

(52) U.S. Cl. 705/42

(57) ABSTRACT

A method and system to mobile based money transaction across different transaction entity. A non-repudiable message, using a first mobile device, is sent to a first transaction entity expressing to provide a token wherein the mobile device is registered with the first transaction entity. The first transaction entity provides a generated token to the first mobile device using non-repudiable messaging services. The first mobile, in turn, transfers the non-repudiable message to a second mobile device of a second user including a token and a transaction entity code. The second mobile device sends the non-repudiable message to a second transaction entity, indicating a token number, a transaction entity code, and sum of money being transferred. The second transaction entity advances the token number, via a non-repudiable message, to a transaction entity indicated by the transaction code to authenticate the token. The first transaction entity authenticates token on receiving from second transaction entity and money being transferred for genuine token as indicated by first transaction machine. Alternatively, the second transaction entity transfers the equivalent sum of money to the first transaction entity indicating money should be transferred to the linked account of the token.

### TECHNICAL FIELD

The present technique relates to a method and system for money transfer between two users, more particularly money transfer using a mobile device, and more particularly electronic money transfer between two transaction banks while transaction is non-repudiable and privacy of users are preserved.

### BACKGROUND

In the current scenario, mobile banking is an essential value added service given by a bank to its customers. This facilitates a customer to initiate transaction like account enquiry, alerts on account activity, credit card enquiry, fund transfer and many more using SMS service provided on his mobile phone. The process is quite flexible as it does not require physical presence of the customer in the bank and the customer need not log into the Internet and being provided by most of the banks now. Mobile payments are expected to become one of the most important applications in m-commerce. They are commonly categorized into micro- and macro payments. The new WAP- and Java-enabled mobile phones using GPRS support a wider variety of banking services such as fund transfers between accounts, stock trading, and confirmation of direct payments via the phone's micro browser. Remote mobile micropayments enable purchases of mobile content and services such as news, games, tickets, and location-based services. Mobile macro payments can be used to pay for larger purchases both electronically (e-commerce, mobile ticketing, gaming) and on manned and unmanned POS (restaurants, retail shopping, and so forth). A software application which provides this service is loaded into the customer's phone. For any transaction, the user initiates software applications provided by the transaction entity, sends an SMS to the transaction entity and complete the transaction. However, such types of mobile phones essentially should be enabled for WAP or JAVA applications. If a user disconnects from using mobile, say he lost his mobile, it will become cumbersome for him to use mobile based transaction. To use same services with a new mobile, the user is required to receive software application, enable all required settings, execute the software application, and finally he will be able to make transaction. This process is complex for any ordinary user who does not have knowledge on loading of software or enabling of necessary settings or execution of software on the mobile device.

The present technique aims to provide a method and system of electronic money transfer using a mobile device wherein the method and system obsolete the execution of any specific application on user's mobile device. Additionally, the present technique also aims to preserve the privacy of service user during transaction process.

### SUMMARY

The summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present technique relates to a method and a device to implement the said method for electronic money transfer using two mobile devices. The method starts with generating a token by a module adapted by a first transaction entity in response to a message received from a mobile device held by a first user. Upon receiving the token, the first user forwards the token number and the first transaction entity identification code, for example each bank is assigned with a particular code number, to a second mobile held by a second user. The second user, in turn, transmits the message to a second transaction entity, for instance a second bank. The message transmitted by the second user comprises a token, a first bank identification code, and the total amount of money desire to transfer.

According to one embodiment of the present technique, the second bank, using a second transaction machine, fires a message to a first transaction machine of first bank. The message comprises a token number and a bank identification code number. On receiving the message by the first bank, a module of first bank authenticates the token and provide response as true token or false token as an example. Subsequently, a message is sent to the second bank, indicating authenticity of message. If message received indicates as a true token, the total quantity of money, as provided by the second mobile device, will be provided to the first transaction machine of the first bank.

According to one embodiment of the present invention, the second bank withdraw, equivalent to the total amount of money as indicated in the message provided by second mobile device, from the account of the second user. Similarly, on receiving the money electronically from the second bank, the first bank deposits the equivalent amount in the account of the first mobile user.

According to one embodiment of the present technique, the method and system for implementing the method provides a secure method of money transaction using mobile phone.

Yet, according to one another embodiment of the present technique, the method and the system incorporates privacy driven money transaction.

### BRIEF DESCRIPTION OF THE DRAWINGS

The above-mentioned and other features and objects of this technique and the manner of obtaining them will become more apparent and the technique itself will be better understood by reference to the following description of embodiments of the technique taken in conjunction with the accompanying drawings wherein:

FIG. 1 is a flow diagram illustrating a method of issuing a token which is being used during transacting money between two transaction entity, according to one exemplary embodiment of the present technique;

FIG. 2A is a flow diagram depicting a method of authenticating a token which is being used during transacting money between two transaction entities, according to one another exemplary embodiment of the present technique;

FIG. 2B is a flow diagram showing a method of transferring token and money, according to one another exemplary embodiment of the present technique;

FIG. 3 is a schematic view illustrating the interaction of mobile devices and transaction entities, according to one another exemplary embodiment of the present technique; and

FIG. 4 is a system illustrating a generalized computer network arrangement, according to one another exemplary embodiment of the present technique.

### DETAILED DESCRIPTION

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the systems and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

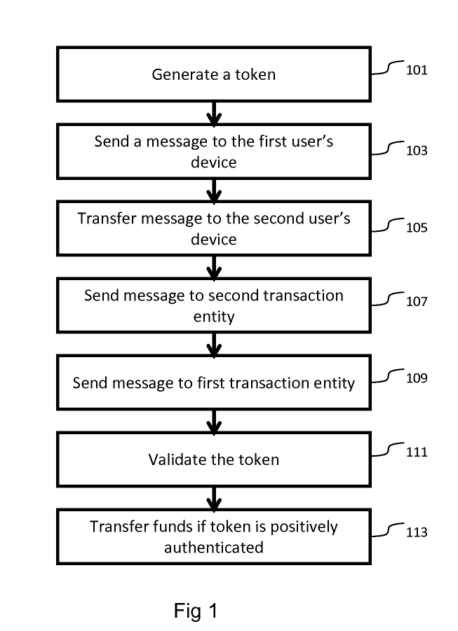

Referring to the figures, FIG. 1 is a flow diagram illustrating a method of issuing a token which is being used during transacting money between two transaction entities, according to one exemplary embodiment of the present technique. The method starts with generating a token in response to a message received from a mobile device of a first user, as represented in step 101, wherein the first user is desirous to receive money in his account. As stated anywhere in the present technique, a transaction entity is an institution enabled to conduct electronic money transaction, for instance a bank. The first user, using his mobile device, sends a message to a transaction entity to generate a token where the user held his money transaction account and has registered his mobile phone for mobile based transactions thereof. As indicated anywhere in the present technique, a mobile device is a hand-held device enabled to send an SMS, for instance a mobile cell or a PDA or a mobile phone or a pager or a telephone. It is noted that a token is a alphanumeric value, for instance a 567tHg. On receiving the message from the first user, if the user is authenticated, a token will be issued by the first transaction entity and it is provided to his mobile device through a message, as indicated in step 103. The contents of message provided by the first transaction entity include a token number and a bank identification code.

Subsequently, the first user, using his first mobile device, transfers the second message to a second mobile device held by a second user, as depicted in step 105. The second user has a money transaction account with a second transaction entity, for instance a second bank, and has registered (or connected) his mobile device with it. The second user, using his mobile device, sends a message to the second transaction entity. The message forwarded by second user to second transition entity includes a token number, a bank identification code, and total amount of money the second user desirous to transfer. As generally known, every bank is assigned with unique code as an identifier of the bank. Similarly, any other transaction entity is also assigned with a unique identifier provided to locate the transaction entity. While the first user is a receiver, the second user is a payee. The first user may request through any means, e.g., email, SMS, voice message, or voice call, to transfer money say, $1000 to his account. However, the second user has control on amount of money being transferred. He may instruct the second transaction entity to transfer equivalent amount or more amounts or less amount of money which is indicated in the message sent to second transaction entity using a second mobile device.

According to one embodiment of the present technique, the second transaction entity transfers the message to the first transaction entity is identified based on the said transaction entity identity code. On receiving the token from the second transaction entity, the first transaction entity initiates a validating process to establish authenticity of it thereof, as depicted in step 111. The first transaction entity compares the said token with the tokens issued by it. It is noted that each generated token is unique. If the token is genuine or false, a communication is shared with the second transaction entity. Subsequently, if the communication from the first transaction entity establishes a genuine of the said token, the money from the second transaction entity is transferred to the first transaction entity (block 113) wherein the second transaction entity debited the equivalent money from the account of second user. Following the transfer of money to first transaction entity, the first transaction entity credits the equivalent sum of money in the account of first user whom the token was issued.

According to one embodiment of the present technique, the message, created using the first mobile device, sent by the first user to the first transaction entity or to the second mobile device of the second user is digitally signed. Similarly, the message generated by the first transaction entity and sent to the first user mobile device or to the second transaction entity is digitally signed. Additionally, the message, generated by the second mobile device of second user, and sent to the first user mobile device or to the second transaction entity is digitally signed. Also, any message, generated by the second transaction entity and sent to the second user mobile device or the first transaction entity is digitally signed. As known to those of skilled in the art, a properly implemented digital signature gives the receiver reason to believe the message was sent by the claimed sender. The digital signatures also provide non-repudiation, i.e., the signer cannot successfully claim they did not sign a message, while also claiming their private key remains secret. It is noted that all necessary steps are accomplished to ensure that all message transfer between users and banks are digitally sign to achieve non-repudiation state. As apparent to those of skilled in the relevant art a digital signature can be generated using crypto from software in the mobile phone or from software in a computer and the result can be typed on to the mobile.

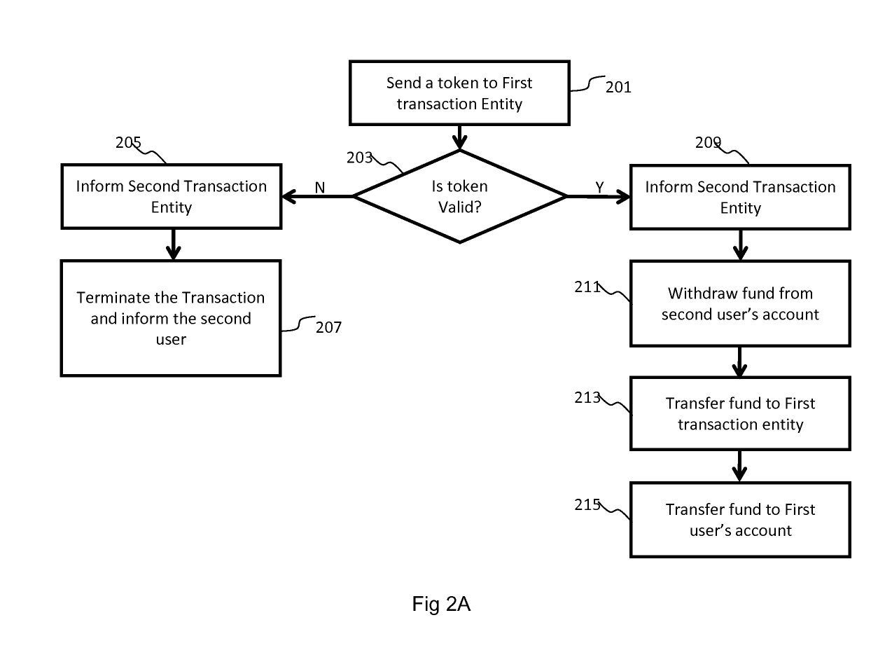

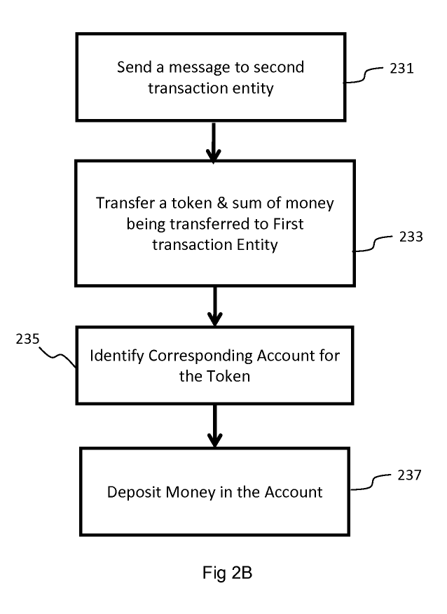

Moving to FIG. 2A, FIG. 2A is a flow diagram depicting a method of authenticating a token which is being used during transacting money between two transaction entities, according to one another exemplary embodiment of the present technique. As indicated anywhere in the present technique, a token is an alphanumeric value and generated by a system incorporated by a transaction entity. As described in any of steps of FIG. 1, the second transaction entity receives a token from a second mobile device of a second user wherein the second user has incorporated his mobile device with the second transaction entity. While incorporating a mobile device of a user, a transaction entity associates details of a user, his mobile number, and his transaction account maintained with the transaction entity. The second user provides the second bank a token number, a transaction identification code, and the sum of money being transferred to the first bank through a message. On receiving a message from the second user, the second transaction entity sends a message to a first transaction entity recognized based on the transaction entity code wherein the message comprises a token number, as indicated in step 201. The message is meant to authenticate a token number provided thereof. On receiving the message, the token is validated by the first transaction entity, as represented by step 203. A token is authenticated as a genuine token or a false token. The ‘genuine token’ is issued by the said first transaction entity while a ‘false token’ is not issued by the said first transaction entity. If a token provided to the authenticating transaction entity, e.g., to the first transaction entity, is a ‘false token’, it will acknowledge the second transaction entity (block 205) the status of token as a ‘false token’ and terminate the transaction process thereafter (block 207). However, if the token is a ‘genuine token’, it will acknowledge the second truncation (block 209) the status of token as a ‘genuine token’, and request for completion of further process in money transaction.

According to one another embodiment of the present technique, equivalent sum of money, as indicated by the second user in a message provided with token and transaction identity code, is withdrawn from the linked account of the second user (block 211), provided sufficient sum of money is available in the account of the second user. Subsequently, equivalent sum of money is transferred from the second transaction entity to the first transaction entity, as shown in step 213. It is noted that the second transaction entity preserves privacy of the second user and doesn't disclose any information about the second user, since it was a transaction on the basis of authenticity of token issued by money receiving transaction entity. Thereafter, the first transaction entity deposits the equivalent sum of money in the account of the first user whom the token was issued initially, as represented in step 215. It is noted that the first transaction is not required to disclose any information about the first user's account and any other details of the first user since the transaction of sum of money is based on ‘genuine token’, therefore preserves the secrecy of the first user.

Turning to FIG. 2B, it is illustrating a process of token transfer and money transaction according to one another exemplary embodiment of the present technique. On receiving a message from first hand-held device, the second hand-held device sends a message including a token received from the first hand-held device, a transaction entity code and a sum of money being transferred, to a second transaction entity, as represented in step 231. The second transaction entity is enabled to receive or send message to the hand-held devices linked with the account of the users wherein a user can be a customer as an example. On receiving the message from the second hand-held device of a user, the second transaction entity verifies if the equivalent sum of money exists in linked account of the second hand-held device. If the linked account contains total balance of money equivalent to the request or more, the second transaction entity withdraws the equivalent sum of money from the linked account hand-held device. Subsequently, the second transaction entity transfers the received token and withdrawn money to first transaction entity as represented in step 233. On receiving the money by the first transaction entity, the first transaction entity identifies the linked account to the said token, as represented in step 235. The received token identifies by exploring to which hand-held device the said token was sent. Since a token is sent to a registered hand-held device of a user and each registered hand-held device is linked with an account of user, the equivalent sum of received money is deposited into the account of the said linked account of the user (block 237). So the first user receives the sum of money from a second user using their registered hand-held devices, which eventually provides them freedom to transfer money anytime from anywhere. And also, since present invention establishes a transaction between two transaction entities based on a token, identity of the users are remained undisclosed to any external resource.

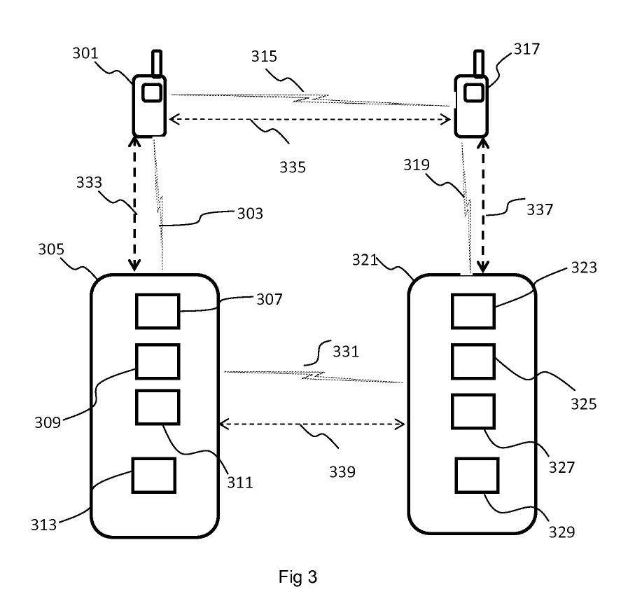

Referring to FIG. 3, it is a schematic view illustrating the interaction of mobile devices and transaction entities, according to one another exemplary embodiment of the present technique. The schematic system diagram displays essential components of a electronic system. As apparent to those of skilled in the art, an electronic system essentially comprises a RAM, a HDD, an interface, an input keys, a processing module to process the queries of a user are used in the present technique, however, it is not shown here. The system components required to implement the process of money transaction, according to one embodiment of the present technique, includes a mobile device 301, a first transaction entity machine 305 comprising a storage module 307 to store the accounts and relevant details of the customers, a message managing module 309, a token generating module 311 and a validating module to authenticate a token 313. The system further comprises a second mobile device 317 and a second transaction entity machine 321 comprising respective a storage module 323 to store the accounts and relevant details of the customers, a message managing module 325, a token generating module 327 and a validating module to authenticate a token 329. The system further comprises a network module 303, 315, 319, and 331 to facilitate communication among various devices and machines, wherein the network module can be, but not limited to, an internet or a WAN, a LAN, a wireless network, a mobile device network.

The first mobile device 301 and the second mobile 317 are enabled to send and receive a message. The mobile devices are further enabled in such a way that all sending messages comprise a digital signature. The first transaction machine 305 and the second transaction machine 321 are adapted to interact with each other and with respective registered mobile devices. To initiate any mobile based transaction, a user is expected to register his mobile device and other relevant information with the machine used by a transaction entity, for example, a first mobile device 301 of a first user is registered with the machine 305 of first transaction entity wherein the mobile device 301 is linked with a storage module 307. When a message to provide a token is received from a mobile device 301, a message managing module 309 receives the message and prompts an acknowledgement message via 333 to the mobile device 301. Thereafter, the message managing module 309 directs a token generating module 311 to generate a token and provide the token via 309 to 301. The mobile device 301 also receives a transaction identity code included in the message, though optionally. Also, the mobile device 301 further optionally sends an acknowledgment via 333 to the machine 305.

Additionally, the mobile device 301 forwards the message via 315 to a second mobile device 317 wherein the message includes a token and a transaction entity code. The token and the transaction entity code may be provided in one message, or optionally, in two different messages wherein each message based transaction is digitally signed. Also, the mobile device 317 may optionally provide an acknowledgement of receipt of a token and transaction entity code. On receiving the message, the mobile device 317 transmits a message, via 319, to the transaction entity 321. The message transmitted to the transaction entity includes a token received from 301, a transaction entity code optionally received from 301, and sum of money desirous to transfer in the linked account of mobile device 301. The message managing module 325 facilitated to receive a message and send a message via network module (319, and 321) sends a message to a transaction entity 305 identified by the respective code. The message contents include a token received from a mobile device 317. On receiving the token in a message from a module 325 of 321, the module 309 acknowledges the module 325 via 339. Also, the module 309 directs a token validating module to establish authenticity of the said token. The token validating module compares the token with stored tokens and determines if the received token is a ‘genuine token’ or a ‘false toke’. If the received token is a ‘false toke’, the message managing module is directed to provide a message to the respective module of the transaction entity 321 indicating received token is a ‘false token’ and terminate any further process, however, if the received token is a ‘genuine token’, the message managing module is directed to provide a message to the respective module of the transaction entity 321 indicating received token is a ‘genuine token’. Optionally, a request is also provided to a respective module to complete the transaction process. If the response for the provided token from the transaction entity machine 305 is indicated as ‘false token’, a message is providing, using message managing module, to the mobile device 317, indicating the forwarded token was incorrect and money traction process is terminated. However, if the received token is a ‘genuine token’ as established by validating module of the transaction entity 305, an equivalent sum of money, as indicated, in a message received from the second mobile is debited from the linked account of mobile device 317, and provided to the machine 305 of transaction entity via 331. An acknowledgement is provided by 305 to 323, indicating receipt of the sum of money. Subsequently, equivalent of the received sum of money is credited in the linked account of mobile device 301.

According to one embodiment of the present technique, money transfer transpired between two transaction entities using token as a method to recognize the linked account, the identity of first user is not disclosed to second transaction entity. The second transaction entity, which has received the token and sum of money being transferred, identifies the first transaction entity using a transaction entity code provided to each transaction entity. Similarly, the identity of second user is not apparent to the first transaction entity since the first bank received the token and sum of money. So the transaction process disclosed in the present technique maintains confidentiality of the account to which the money has been transferred. And the identity of the users or any linked account details of user can't be fetched even though money is transferred electronically.

### Exemplary Computing Environment

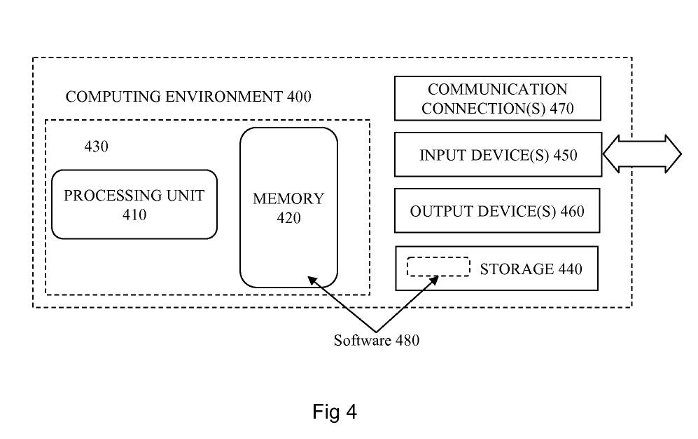

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 700.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

We claim:

1. A method for transferring funds between at least one first user and at least one second user, the first user having a first hand-held device and the second user having a second hand-held device, the first user associated with a first transaction entity and the second user associated with a second transaction entity, the method comprising:
a) generating at least one token in response to at least one first message requesting transfer of funds from the second user to the first user, the first message being sent by the first user using the first hand-held device to at least one machine of a first transaction entity;
b) sending at least one second message to the first hand-held device using the machine of the first transaction entity, the second message comprising the at least one token being transmitted by the first transaction entity;
c) receiving the second message by a second transaction entity from the second hand-held device, wherein the second message is sent to the second hand-held device by the first hand-held device followed by sending the second message using second hand-held device to the second machine of the second transaction entity;
d) validating the second message based on the token by the machine of the first transaction entity, wherein the second message is sent to the first transaction entity by the second transaction entity; and
e) transferring the funds to the first user based on the validation of the second message.

2. The method according to claim 1, wherein the second message comprises at least one a transaction entity code or fund value or combinations thereof.

3. The method according to claim 2, wherein the fund value is inputted by the second user using the second hand-held device.

4. The method according to claim 1, wherein the token is an alphanumeric value.

5. The method according to claim 1, wherein the token is dynamic and for single use.

6. The method according to claim 1, wherein the first and second messages are digitally certified.

7. The method according to claim 1, wherein the first and second messages are communicated using at least one communication network.

8. The method according to claim 1, wherein the first and second hand held devices comprise at least one of a mobile device or cell phone or a pager.

9. The method according to claim 1, wherein the funds are transferred from the second machine of the second transaction entity to the first machine of the first transaction entity.

10. The method according to claim 9, wherein the funds are withdrawn from the account of the second user.

11. The method according to claim 9, wherein account information of the second user associated with the second transaction entity is not disclosed to the first machine of the first transaction entity associated with the account of the first user.

12. The method according to claim 1, wherein the funds are deposited in the account of the first user.

13. The method according to claim 12, wherein account information of the first user associated with the first transaction entity is not disclosed to the second machine of the second transaction entity associated with the account of the second user.

14. A method for transferring funds between at least one first user and at least one second user, the first user having a first hand-held device and the second user having a second hand-held device, the first user associated with a first transaction entity and the second user associated with a second transaction entity, the method comprising:
a) generating at least one token in response to at least one first message requesting transfer of funds from the second user to the first user, the first message being sent by the first user using the first hand-held device to at least one machine of a first transaction entity;
b) sending at least one second message to the first hand-held device using the machine of the first transaction entity, the second message comprising the at least one token being transmitted by the first transaction entity;
c) receiving at least one second message to the second hand-held device from the first hand-held device;
d) sending the second message using a second hand-held device to a second transaction entity wherein the message received from the second hand-held device includes at least one of a token, a transaction entity code, and sum of money being transferred; and
e) transferring the token number and the sum of money to the first transaction entity using the transaction entity code by the second transaction entity.

15. A system for transferring funds between at least one first bank account of the first user and at least one second account of the second user, the first user having a first hand-held device and the second user having a second hand-held device, the first user account is associated with a machine of first transaction entity and the second user account is associated with a machine of a second transaction entity, the system comprising:
a) a module adapted to generate at least one token in response to at least one first message requesting transfer of funds from the second user to the first user, the first message being sent using the first hand-held device by the first user to at least one machine of a first transaction entity;
b) a module adapted to send at least one second message to the first hand-held device, the second message comprising the at least one token being transmitted by the machine of a first transaction entity;
c) a second hand-held device adapted to receive the second message from the first hand-held device;
d) a second hand-held adapted to send the second message to at least one machine of the second transaction machine;
e) a module adapted to validate the second message based on the token, wherein the second message is sent to the first transaction entity by the second transaction entity; and
f) a module adapted by the second transaction machine to transfer funds to the machine of a first transaction entity based on the validation of the second message.

16. The system according to claim 14, wherein the second message sent by the machine of the first transaction entity comprises at least one transaction entity code or fund value or combinations thereof.

17. The system according to claim 15, wherein second hand-held-device is adapted to input the fund value.

18. A system according to claim 14, wherein the token is an alphanumeric value.

19. A system according to claim 14, wherein the token is dynamic and for single use.

20. A system according to claim 14, further comprising a module adapted to enable the first message and the second message are digitally certified.

21. A system according to claim 14, further comprising at least one communication network adapted to enable communication of the message.

22. A system according to claim 14, the first hand held device of the first user or the second hand held device of the second user is a mobile device or cell phone or pager.

23. A system according to claim 14, wherein the first machine of the first transaction entity is enabled to receive the funds from the second machine of the second transaction entity.

24. A system according to claim 14, wherein the second machine of the second transaction entity is enabled to transfer the funds to the first machine of the first transaction entity.

25. A system according to claim 14, wherein the second machine is enabled to withdraw the funds from the account of the second user.

26. A system according to claim 14, wherein the first machine is enabled to deposit the funds in the account of the first user.

27. A system according to claim 14, wherein the first machine of the first transaction entity is enabled not to disclose information of the account of the first user.

28. A system according to claim 14, wherein the second machine of the second transaction entity is enabled not to disclose information of the account of the second user.
